(19) United States
(12) Patent Application Publication
(10) Pub. No.: US 2003/0156759 A1
(43) Pub. Date: Aug. 21, 2003

(54) Background-foreground segmentation using probability models that can provide pixel dependency and incremental training

(75) Inventors: Antonio J. Colmenarez, Maracaibo (VE); Srinivas Gutta, Yorktown Heights, NY (US); Miroslav Trajkovic, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/078,976

(22) Filed: Feb. 19, 2002

(51) Int. Cl. G06K 9/62

(52) U.S. Cl. 382/228

(57) ABSTRACT

Background-foreground segmentation is performed as a maximum likelihood classification. During a training procedure, a system estimates the parameters of likelihood probability models, which are the probability of observing images assuming that the images come from the background scene. During normal operation, the likelihood probability of captured images is estimated using the background models. The background-foreground segmentation is carried out by comparing the likelihood probabilities of the test images with fixed thresholds. The probability of observing foreground objects is assumed constant, as foreground images are generally not modeled. This value, the probability threshold, preferably represents a tunable parameter of the system. Pixels with low likelihood probability of belonging to the background scene are classified as foreground, while the rest are labeled as background.

### FIELD OF THE INVENTION

The present invention relates to background-foreground segmentation performed by computer systems, and more particularly, to background-foreground segmentation using probability models that can provide pixel dependency and incremental training.

### BACKGROUND OF THE INVENTION

Background-foreground segmentation is a well known computer vision based technique for detecting objects in the field of view of a stationary camera. A key element in this technique is that a system learns a scene while no objects are present. This is called training. During training, the system builds a background model using a sequence of images captured from the scene. Then, during normal operation, the system constantly compares new captured images with the background model. Pixel positions with significant deviation from the background model are classified as foreground, while the rest are labeled as background. The output of the algorithm is generally a binary image depicting the silhouette of the foreground objects found in the scene.

A number of different algorithms for background-foreground segmentation have been studied. The difference among these algorithms is mostly related to the choice of models and learning techniques used to capture the background scene. In general, more complex models are expected to perform better at the expense of higher computational requirements.

Conventional background-foreground modeling techniques use models where pixels are considered independent. For instance, the probability of a pixel being a certain color in conventional models is treated as being unrelated to the probability of an adjacent pixel being the same or a different color. In other words, the probability that a pixel is or is not a certain color is completely unrelated to the color of an adjacent pixel. In mathematical terms, independence is stated as the probability of event A occurring given that event B has occurred is the probability of the event A occurring, or P(A|B)=P(A). The latter statement, if true, means that event A is independent from event B.

A problem with treating each pixel as being independent is that many pixels in an image are dependent. For instance, if one pixel is a particular color, it is likely that adjacent pixels are also the same or a similar color.

Another problem with many conventional models used for background-foreground segmentation occurs with training the models. Generally, training is performed by passing a predetermined number of images through the model. Basically, this means that a fixed number of image samples are used and the model parameters are estimated all at once, after all samples have been entered. However, this does not allow many global changes to become part of the background. For example, lighting conditions may change over time, and using a certain number of images may or may not accurately capture the lighting change. With this type of training, if the sample images do not contain certain information, such as lighting changes, then the models for the background also will not model this information.

Consequently, a need exists for techniques that overcome the limitations associated with treating pixels as being independent and with providing insufficient training.

### SUMMARY OF THE INVENTION

Generally, the present invention provides techniques that treat pixels from an image as being dependent in both the local sense (e.g., regions within an image) and global sense (e.g., the whole image or the current image as it relates to other images). These techniques provide background-foreground segmentation, and allow incremental training, where the models are trained over a certain time and parameters of the model are calculated periodically.

Broadly, aspects of the present invention perform background-foreground segmentation as a maximum likelihood classification. During a training procedure, a system estimates the parameters of likelihood probability models, which are the probability of observing images assuming that the images come from the background scene. During normal operation, the likelihood probability of captured images is estimated using the background models. The background-foreground segmentation is carried out by comparing the likelihood probabilities of the test images with a fixed threshold. The probability of observing foreground objects is assumed constant, as foreground images are generally not modeled. The value of the fixed threshold, called a pixel threshold herein, preferably represents a tunable parameter of the system. Pixels with low likelihood probability of belonging to the background scene are classified as foreground, while the rest are labeled as background.

The background probability models used for background-foreground segmentation preferably treat pixels as being dependent by providing a number of global states. Within each state, pixels may also be modeled as being dependent. A preferred model of the present invention uses a collection of Gaussian distributions to model each pixel in connection to a global state. In this embodiment, each pixel is treated as having a number of Gaussian modes and a number of states, and these modes and states may be stored in tables used to determine likelihood probabilities for each pixel.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of an exemplary system for performing background-foreground segmentation in accordance with a preferred embodiment of the invention;

FIG. 2 is a flowchart of a method for classification of input images for a system that performs background-foreground segmentation, in accordance with a preferred embodiment of the invention; and

FIG. 3 is a flowchart of a method for training a system that performs background-foreground segmentation, in accordance with a preferred embodiment of the invention

### DETAILED DESCRIPTION

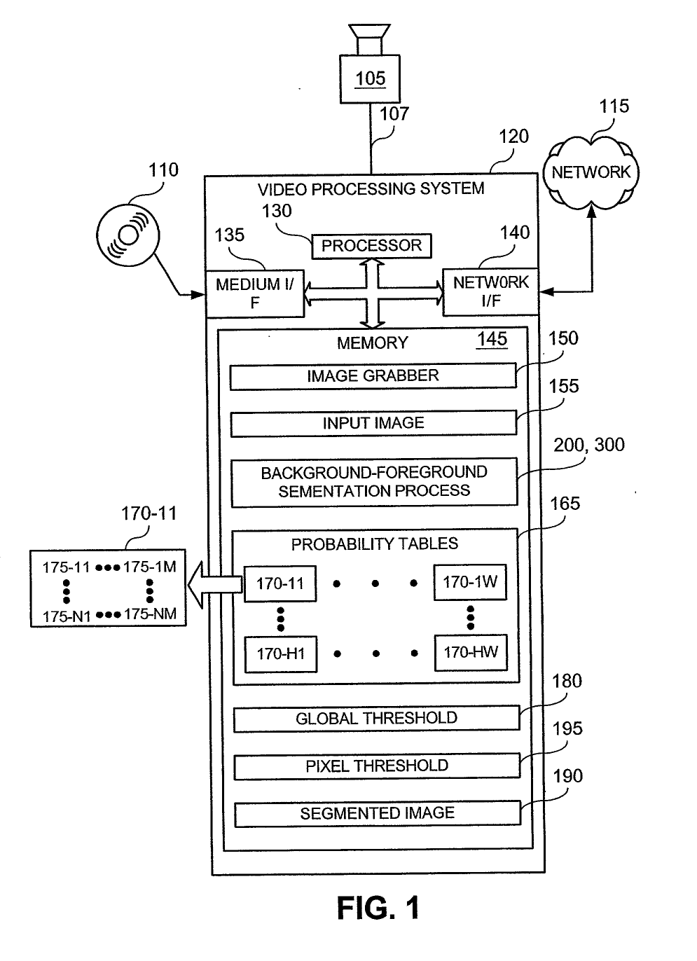

Referring now to FIG. 1, a video processing system 120 is shown that performs background-foreground segmentation in accordance with preferred embodiments of the present invention. Video processing system 120 is shown interoperating with a camera 105 through video feed 107, a Digital Versatile Disk (DVD) 110 and a network 115. Video processing system 120 comprises a processor 130, a medium interface 135, a network interface 140, and a memory 145. Memory 145 comprises image grabber 150, an input image 155, a background-foreground segmentation process 200/300, probability tables 165, a global threshold 180, a pixel threshold 195, and a segmented image 190. Probability tables 165 comprise a plurality of probability tables 170-11 through 170-HW. One probability table 170-11 is shown comprising entries 175-11 through 175-NM.

Video processing system 120 couples video feed 107 from camera 105 to image grabber 150. Image grabber 150 “grabs” a single image from the video feed 107 and creates input image 155, which will generally be a number of pixels. Illustratively, input image 155 comprises H pixels in height and W pixels in width, each pixel having 8 bits for each of red, green, and blue (RGB) information, for a total of 24 bits of RGB pixel data. Other systems may be used to represent an image, but RGB is commonly used.

The background-foreground segmentation process 200, 300 is a process used to perform background-foreground segmentation. Background-foreground segmentation process 200 is used during normal operation of video processing system 120, while background-foreground segmentation process 300 is used during training. It is expected that one single process will perform both processes 200 and 300, and that the single process will simply be configured into either normal operation mode or training mode. However, separate processes may be used, if desired.

During normal operation of video processing system 120, the background-foreground segmentation process 200 uses probability tables 165 to determine likelihood probabilities for each of the H×W pixels in input image 155. Each of the likelihood probabilities is compared with the pixel threshold 195. If the likelihood probability is below pixel threshold 195, then the pixel is assumed to belong to the background. It is also possible to modify probability models used by the background-foreground segmentation process 200 to allow video processing system 120 to assume that a pixel belongs to the background if the likelihood probability for the pixel is greater than the pixel threshold 195. It is even possible for the video processing system 120 to assign a pixel to the background if the likelihood probability for the pixel is within a range of pixel thresholds. However, it will be assumed herein, for simplicity, that a pixel is assumed to belong to the background if the likelihood probability is below a pixel threshold 195.

During normal operation, the background-foreground segmentation process 200 determines the segmented image 190 from the input image by using the probability tables 165 and the pixel threshold 195. Additionally, probability models (not shown) are used by the background-foreground segmentation process 200 to determine the likelihood probability for each pixel. Preferred probability models are discussed below in detail. These probability models are “built into” the background-foreground segmentation process 200 (and 300) in the sense that the background-foreground segmentation process 200 performs a series of steps in accordance with the models. In other words, the background-foreground segmentation process 200 has its steps defined, at least in part, by a probability model or models. For the sake of simplicity, the probability model used to perform the background-foreground segmentation and the background-foreground segmentation process will be considered to be interchangeable. This simplifies description of the present invention. However, it should be noted that the background-foreground segmentation process, while performing the steps necessary to determine probabilities according to a model, may have additional steps not related to determining probabilities according to a model. For instance, retrieving data from input image 155 and storing such data in a data structure is one potential step that is not performed according to a probability model.

During training, the background-foreground segmentation process 300 defines and refines probability tables 170-11 through 170-HW (collectively, “probability tables 170” herein). Preferably, there is one probability table for each pixel of input image 155. Each probability table will have an M×N matrix, illustrated for probability table 170-11 as entries 175-11 through 175-NM (collectively, “entries 175” herein). There will be M global states and N Gaussian modes for each pixel. Generally, each probability table 170 will start with one global state and one Gaussian mode and, after training, contain the M×N entries 175.

During training, global threshold 180 is used by background-foreground segmentation process 300 to determine whether a state should be added or parameters of a selected state modified. The pixel threshold 195 is used, during training, to determine whether another Gaussian mode should be added or whether parameters of a selected Gaussian mode should be adjusted.

It should be noted that the present invention allows training to be incremental. In conventional methods, a number of training images are passed to a background-foreground segmentation process that models the background. The parameters of the model are determined all at once after the training images are input to the background-foreground segmentation process. The present invention allows parameters of the model to be adjusted every time an image is passed to the model or after a predetermined number of images have been passed to the model. The former is preferred although the latter is possible.

As is known in the art, the methods and apparatus discussed herein may be distributed as an article of manufacture that itself comprises a computer-readable medium having computer-readable code means embodied thereon. The computer-readable program code means is operable, in conjunction with a computer system such as video processing system 120, to carry out all or some of the steps to perform the methods or create the apparatuses discussed herein. The computer-readable medium may be a recordable medium (e.g., floppy disks, hard drives, compact disks such as DVD 110 accessed through medium interface 135, or memory cards) or may be a transmission medium (e.g., a network 115 comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk, such as DVD 110.

Memory 145 will configure the processor 130 to implement the methods, steps, and functions disclosed herein. The memory 145 could be distributed or local and the processor 130 could be distributed or singular. The memory 145 could be implemented as an electrical, magnetic or optical memory, or any combination of these or other types of storage devices. The term “memory” should be construed broadly enough to encompass any information able to be read from or written to an address in the addressable space accessed by processor 130. With this definition, information on a network, such as network 115 accessed through network interface 140, is still within memory 145 of the video processing system 120 because the processor 130 can retrieve the information from the network. It should also be noted that all or portions of video processing system 120 may be made into an integrated circuit or other similar device, such as a programmable logic circuit.

Now that a system has been discussed, probability models will be discussed that can provide global and local pixel dependencies and incremental training.

Probability Models

In a preferred probabilistic framework, images (i.e., two-dimensional array of pixel appearances) are interpreted as samples drawn from a high-dimensional random process. In this process, the number of pixels of the image defines the number of dimensions. More formally, let I={I_{x,y}εΘ^{WH}} represent an image of W×H pixels with values in the observation space Θ (i.e., RGB values at 24 bits per pixel).

The probability distributions associated with that random process, P(I|Ω), would capture the underlying image-generating process associated with both the scene and the imaging system. This includes the colors and textures present in the scene as well as the various sources of image variations such as motion in the scene, light changes, auto-gain control of the camera, and other image variations.

Most conventional algorithms model the images of a scene assuming each of the pixels as independent from each other. In practice, the image-formation processes and the physical characteristics of typical scenes impose a number of constraints that make the pixels very much inter-dependant in both the global sense (i.e., the whole image or a series of images) as well as in the local sense (i.e., regions within the image).

The proposed model of the present invention exploits the aforementioned dependency among the pixels within the images of a scene by introducing a hidden process ξ that captures the global state of the observation of the scene. For example, in the case of a scene with several possible illumination settings, a discrete variable ξ could represent a pointer to a finite number of possible illumination states.

A basic idea behind the proposed model is to separate the model term that captures the dependency among the pixels in the image from the one that captures the appearances of each of the pixels so that the problem becomes more tractable. That is, it is beneficial to compute the likelihood probability of the image from:

$$P ( I \vert Ω ) = {\sum }_{∀ ξ} P ( I \vert ξ , Ω ) P ( ξ \vert Ω ) , \qquad [ 1 ]$$

where P(ξ|Ω) represents the probability of the global state of the scene, and P(I|ξ,Ω) represents the likelihood probability of the pixel appearances conditioned to the global state of the scene ξ. Note that as the dependency among the pixels is captured by the first term, it is reasonable to assume that, conditioned to the global state of the scene ξ, the pixels of the image I are independent from each other. Therefore, Equation [1] can be re-written as:

$$P ( I \vert Ω ) = {\sum }_{∀ ξ} P ( ξ \vert Ω ) {\prod }_{∀ ( x , y )} P ( {I}_{x , y} \vert ξ , Ω ) , \qquad [ 2 ]$$

where P(I_{x,y}|ξ,Ω) represents the probability used to model the (x,y) pixel of the image I.

Depending upon the complexity of the model used to capture the global state of the observation of a scene, namely P(ξ|Ω), the implemented process would be able to handle different types of imaging variations present in the various application scenarios. For example, it is feasible to implement a background-foreground segmentation process robust to the changes due to the auto-gain control of a camera, if a parameterized representation of the gain function is used in the representation of ξ.

In the interest of simplicity, each of the pixel values conditioned to a global state ξ, P(I_{x,y}|ξ,Ω), is modeled using a mixture-of-Gaussian distribution with full covariance matrix in the three-dimensional RGB-color space. More formally, one can use the following equation:

$$P ( {I}_{x , y} \vert ξ , Ω ) = {\sum }_{∀ α} P ( {α}_{x , y} ) N ( I ; {\overline{I}}_{α , x , y} , {\sum }_{α , x , y} ) ,$$

where \overline{I}_{α,x,y} and Σ_{α,x,y} are the mean value and the covariance matrix of the α-th mixture-of-Gaussian mode for the (x,y) pixel. These parameters are a subset of the symbolic parameter variable Ω used to represent to whole image model.

Note that previous research has shown that other color spaces are preferable to deal with issues such as shadows, and this research may be used herein if desired. However, the present description will emphasize modeling the global state of the scene.

The global state of the observation of a scene is preferably modeled using a discrete variable ξ={1, 2, . . . , M} that captures global and local changes in the scene, so that Equation [2] becomes the following:

$$P ( I \vert Ω ) = {\sum }_{∀ ξ} P ( {α}_{x , y} ) {\prod }_{∀ ( x , y )} {\sum }_{∀ α} P ( {α}_{x , y} ) N ( I ; {\overline{I}}_{α , x , y} , {\sum }_{α , x , y} ) . \qquad [ 3 ]$$

Note the difference between the described model and the traditional mixture of Gaussians. The model of the present invention uses a collection of Gaussian distributions to model each pixel in connection to a global state, as opposed to a mixture-of-Gaussian distribution that models each of the pixels independently.

Equation 3 can be re-written as the following:

$$P ( I \vert Ω ) = {\sum }_{∀ ξ} {\prod }_{∀ ( x , y )} {\sum }_{∀ α} G ( ξ , {α}_{x , y} ) N ( I ; {\overline{I}}_{α , x , y} , {\sum }_{α , x , y} ) , \qquad [ 4 ]$$

where the term

$$G ( ξ , {α}_{x , y} ) = P ( ξ \vert Ω ) \frac{1}{WH} P ( {α}_{x , y} )$$

can be simply treated as M×N matrixes associated with each of the pixel positions of the image model. In this example, M is the number of global states, and N is the number of Gaussian modes. In the example of FIG. 1, the M×N matrixes are stored in probability tables 165, where there is one M×N matrix 170 for each pixel.

Segmentation Procedure

Assuming that one of the proposed models, shown above, has been successfully trained from a set of image observations from a scene, the segmentation procedure of a newly observed image is simply based on maximum likelihood classification. Training is discussed in the next section.

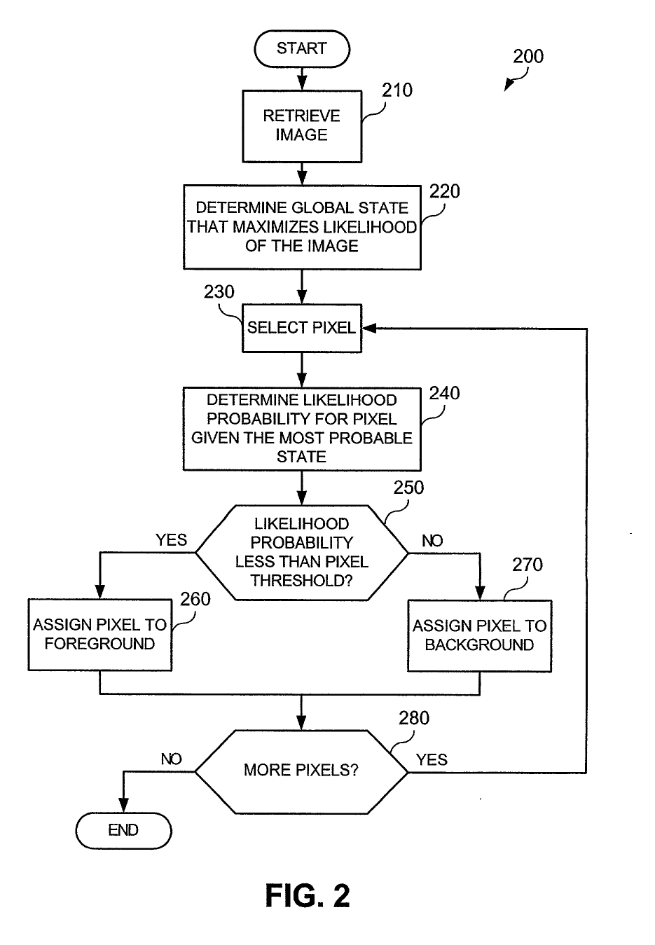

An exemplary segmentation procedure is shown as method 200 of FIG. 2. Method 200 is used by a system during normal operation to perform background-foreground segmentation. As noted above, training has already been performed.

Method 200 begins in step 210 when an image is retrieved. Generally, each image is stored with 24 bits for each pixel of the image, the 24 bits corresponding to RGB values. As described above, other systems may be used, but exemplary method 200 assumes RGB values are being used.

Given the test image, I^{t}, the segmentation algorithm determines (step 220) the global state ξ* that maximizes the likelihood probability of the image given the following model:

$${ξ}^{*} = arg max P ( ξ \vert Ω ) {\prod }_{∀ ( x , y )} P ( {I}_{x , y}^{t} \vert ξ , Ω ) . \qquad [ 5 ]$$

Then, the background-foreground segmentation is performed on each pixel independently using the individual likelihood probability, but only considering the most likely global state ξ*. To perform this step, a pixel is selected in step 230. The individual likelihood probability for each pixel is determined for the most likely global state (step 240), and the likelihood probability is used in the following equation to determine whether each pixel should be assigned to the background or foreground (step 250):

$${s}_{x , y} = \{ \begin{matrix}1 & P ( {ξ}^{*} \vert Ω ) P ( {I}_{x , y}^{t} \vert {ξ}^{*} , Ω ) < {P}_{th} \\ 0 & otherwise\end{matrix} ∀ ( x , y ) , \qquad [ 6 ]$$

where s={s_{x,y}∀(x, y)} represents a binary image of the background-foreground segmentation, where non-zero pixels indicate foreground objects. Basically, Equation [6] states that, if the likelihood probability for a pixel is less than a pixel threshold (step 250=YES), then the pixel is assigned to the foreground (step 260), else (step 250=NO) the pixel is assigned to the background (step 270). Equation [6] is performed for each pixel of interest, which is generally all pixels in an image. Thus, in step 280, if all pixels in the image have been assigned to the background or foreground (step 280=NO), then the method 200 ends, else (step 280=YES) the method continues in step 230 and Equation 6 is performed for a newly selected pixel.

Note how it is possible for process 200 to successfully classify a pixel as foreground even in the case that its color value is also modeled as part of the background under a different global state. For example, if a person wearing a red shirt walks by in the back of the scene during the training procedure, the red color would be captured by one of the mixture-of-Gaussian modes in all the pixels hit by that person's shirt. Later during testing, if that person walks again in the back of the scene (of course, roughly following the same path) he or she will not be detected as foreground. However, if that person comes close to the camera, effectively changing the global state of the scene, his or her red shirt would be properly segmented even in the image regions in which that red has been associated with the background.

As an additional example, consider the case in which a part of the background looks (i) black under dark illumination in the scene, and (ii) dark green when the scene is properly illuminated. The models of the present invention, which exploit the overall dependency among pixels, would be able to detect black objects of the background when the scene is illuminated, as well as green foreground objects when the scene is dark. In traditional models, both black and green would have been taken as background colors, so that those objects would have been missed completely.

Training Procedure

Offline training the proposed models with a given set of image samples (e.g., a video segment) is straightforward using the Expectation-Maximization (EM) algorithm. For example, the parameters of the individual pixel models,

$$P ( {I}_{x , y}^{t} \vert {ξ}^{*} , Ω ) ,$$

could be initialized randomly around the mean of the observed training data, while the probability of the individual states could be initialized uniformly. Then, using EM cycles, all the parameters of the model would be updated to a local-maximum solution, which typically is a good solution. The EM algorithm is a well known algorithm and is described, for instance, in A. Dempster, N. Laird, and D. Rubin, “Maximum Likelihood From Incomplete Data via the EM Algorithm,” J. Roy. Statist. Soc. B 39:1-38 (1977), the disclosure of which is hereby incorporated by reference.

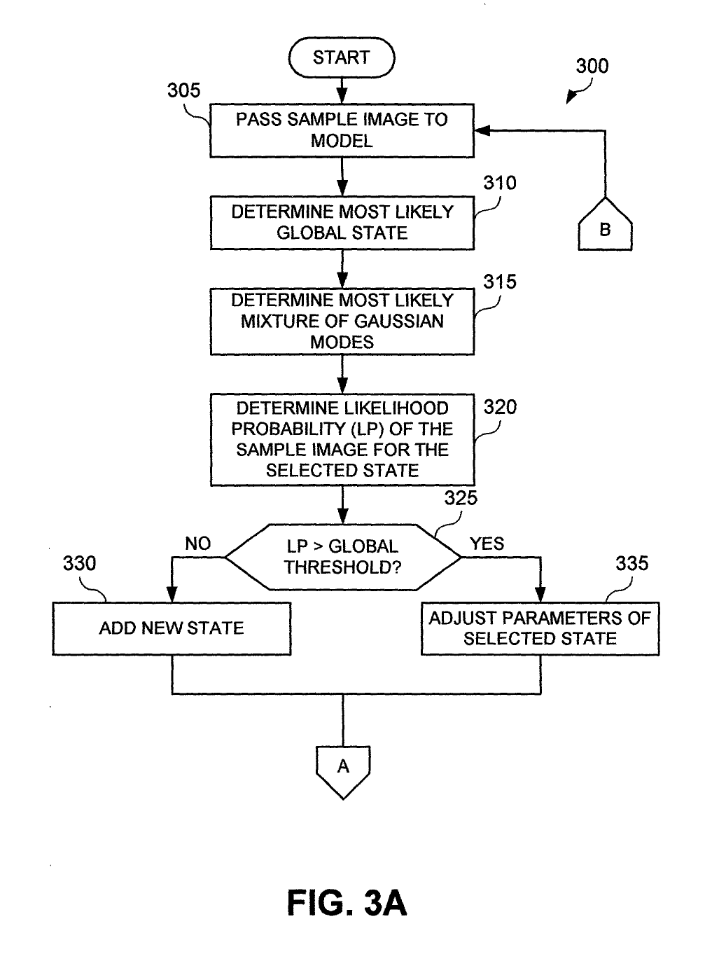

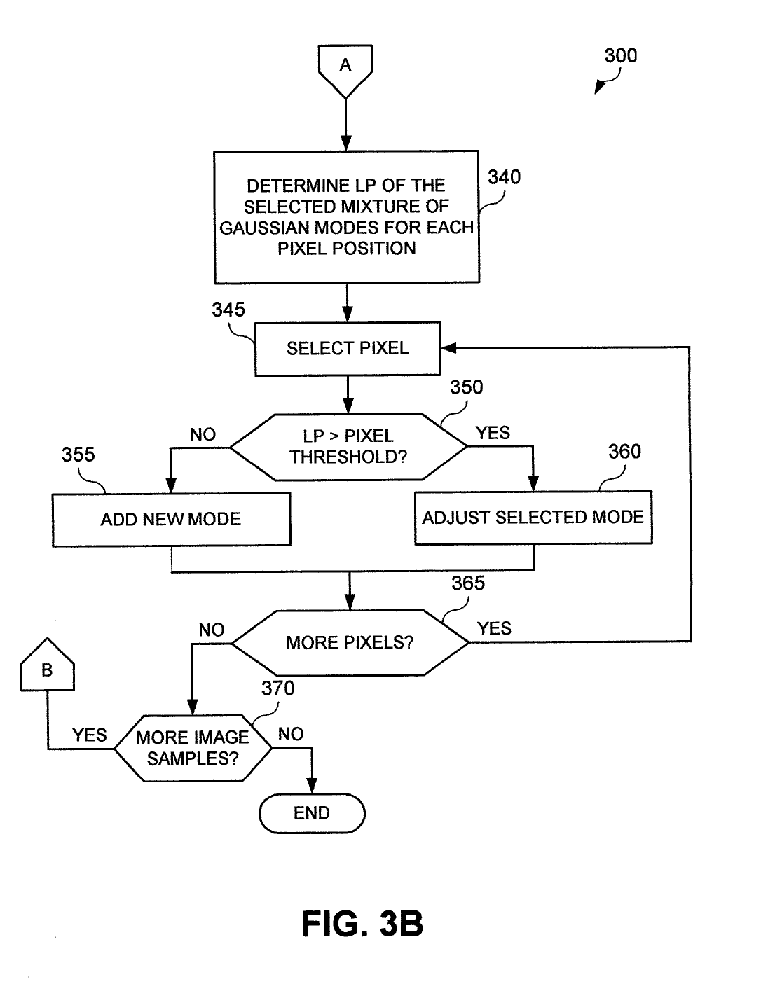

However, the training procedure described in FIG. 3 pursues two issues of great relevance for the real-time implementation of the modeling techniques of the present invention: (1) the incremental training of the models, and (2) the automatic determination of the appropriate number of global states.

Incremental training of the models is desired to allow the processes to run continuously over long periods of time, in order to capture a complete set of training samples that include all the various image variations of the modeled scene.

The automatic determination of the number of global states is also desired to minimize the size of the model, which, in turn, reduces the memory requirements of the process and speeds up the background-foreground segmentation procedure.

An exemplary training process is shown in FIG. 3. This exemplary training process comprises an incremental procedure in which an unlimited number of training samples can be passed to the model. Every time a new sample image is passed to the model (i.e., a new image It passed to the model in step 305), the process 300 first executes an expectation step (E-step, from the EM algorithm) determining the most likely global state ξ* (step 310) and the most likely mixture-of-Gaussian mode, α_{x,y}, of each pixel of the image (step 315). Note that these steps are similar to steps in the segmentation procedure process 200.

In step 320, the likelihood probability of the same image for the selected state is determined. Then, depending upon the value of the likelihood probability of the sample image for the selected global state (step 325), the process 300 selects between adjusting the parameters of the selected state (step 335) or adding a new one (step 330). If the likelihood probability of the sample image for the selected state is greater than a global threshold (step 325=YES), then the parameters of the selected state are adjusted (step 335). If the likelihood probability of the sample image for the selected state is less than or equal to a global threshold (step 325=NO), then a new state is added (step 330).

In step 340, the individual likelihood probabilities of the selected mixture-of-Gaussian modes for each pixel position are determined. Then, depending upon the individual likelihood probabilities of the selected mixture-of-Gaussian modes for each pixel position, the algorithm selects between adjusting the selected modes or adding new ones. To do this, in step 345, a pixel is selected. If the individual likelihood probability of the selected mixture-of-Gaussian modes for this pixel position is greater than a pixel threshold (step 350=YES), then the selected mode is adjusted (step 360), else (step 350=NO) a new mode is added (step 355). If there are more pixels (step 365=YES), the method 300 continues in step 345, else (step 365=NO), the method continues in step 370. If there are more sample images to process (step 370=YES), the method 300 continues in step 305, else (step 370=NO) the method ends.

Note that two thresholds are preferably used in the training method 300: one for the decision at each pixel position, and the other for the decision about the global state of the image.

Each mixture-of-Gaussian mode of every pixel position preferably keeps track of the total number of samples used to compute its parameters, so that when a new sample is added, the re-estimation of the parameters is carried out incrementally. For example, means and covariances of the mixture-of-Gaussian modes are simply updated using:

$${\overline{I}}_{α , x , y} = \frac{1}{( 1 + {K}_{α , x , y} )} [ {I}_{x , y}^{t} + {K}_{α , x , y} {\overline{I}}_{α , x , y} ] ,$$

$${\sum }_{α , x , y} = \frac{1}{{K}_{α , x , y}} [ {( {I}_{x , y}^{t} - {\overline{I}}_{α , x , y} )}^{′} ( {I}_{x , y}^{t} - {\overline{I}}_{a , x , y} ) + ( 1 - {K}_{α , x , y} ) {\sum }_{α , x , y} ] ,$$

where K_{α,x,y} is the number of samples already used for training that mixture-of-Gaussian mode.

Similarly, each global state keeps track of the total number of samples used for training, so that when a sample is added, the probability tables G(ξ,α_{x,y}) are updated using the usage statistics of the individual states and mixture-of-Gaussian modes, considering the addition of the new sample.

Beneficially, the overall model is initialized with only one state and one mixture-of-Gaussian mode for each pixel position. Also, a minimum of 10 samples should be required before a global state and/or a mixture-of-Gaussian mode is used in the expectation step (steps 315 and 320).

Additional Embodiments

It is a common practice to approximate the probability of a mixture of Gaussians with the Gaussian mode with highest probability to eliminate the need for the sum, which prevents the further simplification of the equations.

Using that approximation at both levels, (a) the sum of the mixtures for each pixel becomes the following:

$${\sum }_{∀ α} G ( ξ , {α}_{x , y} ) N ( I ; {\overline{I}}_{α , x , y} , {Σ}_{α , x , y} ) \approx {max}_{x , y} G ( ξ , {α}_{x , y} ) N ( I ; {\overline{I}}_{α , x , y} , {Σ}_{α , x , y} ) ,$$

and (b) the sum of the various global states becomes the following:

$${\sum }_{∀ α} P ( I \vert ξ , Ω ) P ( ξ \vert Ω ) \approx {max}_{ξ} P ( I \vert ξ , Ω ) P ( ξ , Ω ) .$$

Equation [4] simplifies to the following:

$$P ( I \vert Ω ) \approx {max}_{ξ} {\prod }_{∀ ( x , y )} {max}_{{α}_{x , y}} G ( ξ , {α}_{x , y} ) N ( I ; {\overline{I}}_{α , x , y} , {Σ}_{α , x , y} ) . \qquad [ 7 ]$$

Note the double maximization. The first one, at pixel level, is used to determine the best matching Gaussian mode considering the prior of each of the global states. The second one, at image level, is used to determine the state with most likelihood probability of observation.

Another common practice to speed up the implementation of this family of algorithms is the computation of the logarithm of the probability rather than the actual probability. In that case, there is no need for the evaluation the exponential function of the Gaussian distribution, and the product of Equation [7] becomes a sum which can be implemented using fixed-point operations because of the reduced range of the logarithm.

It should be noted that the models described herein may be modified so that a test step currently written to perform one function if a probability is above a threshold may be re-written, under modified rules, so that the same test step will perform the same function if a probability is below a threshold or in a certain range of values. The test steps are merely exemplary for the particular example model being discussed. Different models may require different testing steps.

It is to be understood that the embodiments and variations shown and described herein are merely illustrative of the principles of this invention and that various modifications may be implemented by those skilled in the art without departing from the scope and spirit of the invention.

What is claimed is:

1. A method, comprising:
retrieving an image comprising a plurality of pixels; and
determining at least one probability distribution corresponding to the pixels of the image, the step of determining performed by using a model wherein at least some pixels in the image are modeled as being dependent on other pixels.

2. The method of claim 1, wherein the model comprises a term representing a probability of a global state of a scene and a term representing a probability of pixel appearances conditioned to the global state of the scene.

3. The method of claim 2, wherein the pixels of the image are considered to be independent in the probability of pixel appearances conditioned to the global state of the scene, and the probability of pixel appearances conditioned to the global state of the scene is modeled as a plurality of probabilities that model each pixel of the image.

4. The method of claim 1, wherein the method further comprises the steps of:
providing a training image to the model;
determining parameters of the model; and
performing the step of providing a training image and determining parameters for a predetermined number of training images.

5. A method, comprising:
determining a global state that maximizes a likelihood probability of an image comprising a plurality of pixels;
determining, for each of at least one pixels of an image, an individual likelihood probability; and
assigning, for each of at least one pixels of an image, a pixel to a foreground when the pixel has a predetermined individual likelihood probability.

6. The method of claim 5, wherein the step of assigning, for each of at least one pixels of an image, a pixel to a foreground when the pixel has a predetermined individual likelihood probability further comprises the step of assigning, for each of the at least one pixels of an image, a pixel to a foreground when the pixel has an individual likelihood probability below a pixel threshold.

7. The method of claim 5, further comprising the step of determining a plurality of states associated with a camera view.

8. The method of claim 7, wherein the step of determining a plurality of states further comprises the steps of:
determining a most likely global state for a sample image;
determining a most likely mixture of Gaussian modes;
determining a likelihood probability of the sample image for the most likely global state;
determining if the likelihood probability of the sample image is greater than a global threshold;
adding a new state when the likelihood probability of the sample image is less than or equal to the global threshold; and
adjusting parameters of the most likely global state when the likelihood probability of the sample image is greater than the global threshold.

9. The method of claim 8, further comprising the steps of, for each of the at least one pixels:
determining a likelihood probability for a mixture of Gaussian modes associated with the pixel;
adjusting parameters of a Gaussian mode for the pixel when the likelihood probability for the mixture of Gaussian modes associated with the pixel is greater than a pixel threshold; and
adding a new Gaussian mode when the likelihood probability for the mixture of Gaussian modes associated with the pixel is less than or equal to a pixel threshold.

10. The method of claim 5, further comprising creating a segmented image from the at least one pixel, the segmented image comprising foreground and background pixels, wherein the foreground pixels are represented as one value and the background pixels are represented as another value.

11. The method of claim 5, wherein the likelihood probability of the image and the likelihood probabilities for the pixels are determined according to a probability model.

12. The method of claim 11, wherein the model comprises a term representing a probability of a global state of a scene and a term representing a probability of pixel appearances conditioned to the global state of the scene.

13. The method of claim 11, wherein the model is trained through the following steps:
providing a training image to the model;
determining parameters of the model; and
performing the step of providing a training image and determining parameters for a predetermined number of training images.

14. A system comprising:
a memory that stores computer-readable code; and
a processor operatively coupled to said memory, said processor configured to implement said computer-readable code, said computer-readable code configured to:
determine a global state that maximizes a likelihood of probability of an image comprising a plurality of pixels;
determine, for each of at least one pixels of an image, an individual likelihood probability; and
assign, for each of at least one pixels of an image, a pixel to a foreground when the pixel has a predetermined individual likelihood probability.

15. An article of manufacture comprising:
a computer-readable medium having computer-readable code means embodied thereon, said computer-readable program code means comprising:
a step to determine a global state that maximizes a likelihood of probability of an image comprising a plurality of pixels;
a step to determine, for each of at least one pixels of an image, an individual likelihood probability; and
a step to assign, for each of at least one pixels of an image, a pixel to a foreground when the pixel has a predetermined individual likelihood probability.
